(19) United States
(12) Patent Application Publication
(10) Pub. No.: US 2013/0041733 A1
(43) Pub. Date: Feb. 14, 2013

(54) SYSTEM, METHOD, AND COMPUTER PROGRAM PRODUCT FOR TIP SHARING USING SOCIAL NETWORKING

(71) Applicants: Reise Officer, Louisville, KY (US); John Alexander Lea, Louisville, KY (US); Ben Ishiyama-Levy, Louisville, KY (US)

(72) Inventors: Reise Officer, Louisville, KY (US); John Alexander Lea, Louisville, KY (US); Ben Ishiyama-Levy, Louisville, KY (US)

(21) Appl. No.: 13/570,705

(22) Filed: Aug. 9, 2012

Related U.S. Application Data
(60) Provisional application No. 61/522,481, filed on Aug. 11, 2011.

(51) Int. Cl. G06Q 30/02

(52) U.S. Cl. 705/14.16

(57) ABSTRACT

A system, method, and computer program product for making a product recommendation that pays cash or non-cash awards to a network of tip sharers/providers. The system may be used to increase traffic to a business by sharing recommendations, which may include discounts or other exclusive offerings, to network connections that may be interested in buying a product or service, or engaging in any activity, of the business. A user of the system shares a tip or recommendation with their friend, this friend becomes a customer after making use of the tip, and a fee paid by the business is used to pay cash incentives to the individual who provided the tip and/or the customer who purchased the product based upon the tip. Additional embodiments are also described for sharing cash incentives with a greater network of individuals including those that invite others to join the tip sharing system.

### CROSS REFERENCE TO RELATED APPLICATION

The present application claims priority benefit under 35 U.S.C. §119 (e) to U.S. Provisional Patent Application No. 61/522,481 filed Aug. 11, 2011 by Reise Officer, entitled “System and Method for Tip Sharing Using Social Networking”. The present application incorporates the foregoing disclosure herein by reference.

### BACKGROUND

1. Technical Field

The present invention relates generally to the field of sharing tips or recommendations with network connections through a social networking medium and a compensation scheme for rewarding those that pass along tips, utilize tips, or invite new friends or businesses to join.

2. Discussion of the Related Art

The use of the internet and technologies which make use of the internet has expanded considerably in recent years. Consumerism in particular has gravitated towards the Internet and technologies that use the Internet. Consumers are able to go to the website of a business and download a coupon before making a purchase at the business. Special holidays, such as Black Friday, drive consumers to look for discounts on the Internet. Shopping for coupons on the Internet is the new alternative to cutting coupons from the newspaper.

Some customers are difficult to target through traditional media. Traditional Internet based advertising methods include banner type ads or pop up ads which are often ignored. Targeted advertising from an individual to another individual with an established relationship in a social network is more likely to be looked at and to lead to a purchase.

Friends pass recommendations to friends, coworkers, or other acquaintances all the time in everyday life. The idea of paying a commission for a referral or recommendation that is used incentivizes an individual to pass along positive experiences at a business or with a product or activity to those that are likely to take advantage of said referral or recommendation.

One relatively new idea is that of using cell phones to locate the position of an individual. Using this information, an application can keep a record of where an individual travels within a city and can keep a record of what businesses an individual frequents.

Various prior art methods have addressed these issues, including:

U.S. Pat. No. 7,774,229 Dernehl, et al. which describes a pyramid scheme for paying commissions for referrals. Rewards in the form of tokens in exchange for promotional assistance are mentioned. Spreading the word via email using coupon codes and a rewards system for referrer and all intermediate referrers is discussed. The reward is a cash discount at the time of transaction and the referral system is initiated online for physical world purchases. A distributed method for cash rewards as well as limited pyramid metering, wherein the pyramid cuts off at a certain point and rewards are no longer delivered, are also discussed. However, there is no referral fee paid by the business until a product is sold, it is based on email, and it focuses on a flat rate referral fee rather than the percentage of referral fee of the present invention, and there are limits placed on how many times email messages can be passed.

U.S. Pat. No. 7,904,511 Ryan et al which describes a system of providers and participants in a predetermined application via a data network which can include consumer decisions or recommendations, wherein a provider is a user entity providing an item or service to at least one other user entity; and a participant is a user entity utilizing said provider's item or service. However, users of the social network are simply permitted to use external applications and specific functionality of external applications is not described.

U.S. Pat. No. 7,933,893 Walker et al discloses sharing text and a link related to a preference associated with a third party offer providing the user a monetary benefit for including the preference. However, this invention is specific to a URL and text that emerges in a balloon window while a pointer is placed over the located data pattern and viewpoints are defined for users, they are not given the option of determining a viewpoint and then sharing it.

U.S. Pat. No. 7,263,505 Forlai discloses displaying an offer at a highly discounted rate to increase traffic to a website as well as customizing the offer for product or service based on the profile of a user. This patent indicates displaying an offer for use for a finite period of time and making an offer available at random or unpredictable time and also talks about intelligently directing sale offers to increase likelihood of acceptance of sale offer. However, this patent is limited by saying that the discounted cost of product or service should be essentially at production cost and discusses displaying an ad on a company's website for a short period of time as opposed to spreading the word about the discount in a viral manner. Further, the patent discusses randomly generating sale offers as opposed to them being determined by the business or other methods.

Other prior art systems include various websites including www.wereward.com, www.checkpoints.com, www.shopkick.com, and www.clkclk.com, all of which also have smartphone applications. Many of the applications are social location based that reward users for visiting stores and looking at various products or completing various tasks, which may include the purchase of items. Some existing applications such as www.gowalla.com and www.foursquare.com allow users to explore their city by checking in at various locations and receiving travel stamps or updating their location within the application to make their friends aware.

However, these websites and smartphone applications are only applicable to physical businesses or, in the case of www.wereward.com, the online retail of physical products. Rewards are not offered for making recommendations to friends.

Accordingly, there is a need for a system of recommendation which enables businesses to reach out to vast numbers of interested potential customers, including those who are hard or costly to target through traditional media, in which all parties derive direct monetary gain and/or additional benefits from every transaction. The tip sharing system, which combines the offering of recommendations to friends with social networking and smart phone technologies, creates a highly viral method for businesses to acquire a new customer base through the use of technology and human relationships.

### SUMMARY OF THE INVENTION

A system and method for tip sharing using social networking is presented. The normal behavioral pattern of passing recommendations to friends is monetized in such a way that all parties benefit. Three categories of users comprise the proposed system and method of tip sharing: consumers, tip providers, and businesses. Consumers, who can also be thought of as users or customers, use the system of tip sharing to receive discounts or recommendations. Tip providers, who as well as being consumers, also provide tips and introduce new users to the service. Tip able businesses use the system of tip sharing as a promotional tool to attract new consumers virally as well as to remarket to existing customers through personal recommendations.

The social recommendation engine presented here is a fast and precise method for businesses to reach out to potential consumers who will be interested in their product or service. Every individual has an unrivalled understanding of the needs, wants and characteristics of their friends, and they leverage this knowledge when passing on a recommendation. People also associate with people of similar circumstances and interests, so the friend receiving a recommendation will have other friends with similar needs or requirements. A repeating cycle of recommendations will therefore reach a large number of likely interested parties as people become the marketing engine behind the system and method of tip sharing presented here.

The system and method stimulates the tip sharing dynamic in several ways. In the preferred embodiment, the recipient of the tip who then chooses to become a consumer is given extra value in the form of a meaningful discount or other exclusive offering, which may include an upgrade, cash equivalent payment (such as points to be redeemed later for products or services), or any other incentive. Tips posted within the system for tip sharing or through any of the social networking media might include the integration of pictures, videos or other media uploaded and associated with the tip. The tip provider is given an incentive in the form of a commission for every friend who acts on one of their recommendations. Sharing a single tip with other individuals can result in multiple rewards because when a user shares a tip it can be redeemed multiple times by multiple people. If an individual shares or publishes a recommendation, they would be rewarded each time the recommendation is redeemed. When one recommendation is shared, there is potential to be rewarded multiple times. When a tip is shared and redeemed, if the person redeeming the tip is not yet a member of the system for tip sharing, then the tip provider is also an introducer and would then always receive a commission whenever the person they introduced redeems a tip. The action of sharing a single tip can lead to an unending stream of rewards when it results in new people joining the system for tip sharing.

A tip can refer to three distinct parts of the value chain: first, an activity, a transaction, or a micro task that can be exchanged for value; second, a recommendation from one individual to another; and third, a commission earned from a recommendation.

Tips can be any activity that can be exchanged for value. A business, individual, or entity within the network of the system for tip sharing put out a tip for different micro tasks. One such task might include taking a picture of a business for a reward which might include monetary or cash equivalent rewards. Various different parties are involved with the tip process. The mix of their responses and corresponding attributes (e.g. geo location) when processed through the algorithms within the system for tip sharing authenticate the integrity of the transaction. The system for tip sharing therefore has the ability to become a contracted distributed workforce to execute micro work campaigns in place of having employees execute the work. Tips can be matched with members of the system for tip sharing based on demographics or usage and distributed to potentially interested parties.

The system for tip sharing may use third party data sources to enrich and validate customer data in order to improve tip targeting to tip providers and consumers. Additionally, the system for tip sharing may use third party data to enrich, validate, and/or verify customer data to understand what they buy so as to identify new businesses that need to be invited to join the network of tip able businesses. Third party data may be used to source user driven content in order to properly time the offering of certain relevant tips. As an example, if a consumer within the system for tip sharing produces user-generated content (UGC) that says they are an expecting mother, that data may be used to target that individual near real time on finding appropriate offers.

In alternate embodiments of the invention, the rewards system is extended to individuals that introduce new members. This would extend to the situation when a friend who is not a member of the system of tip sharing acts on a recommendation for the first time. Every subsequent time the new member redeems a tip, the person that introduced them to the system for tip sharing receives a reward. Therefore, the single action of sending a recommendation to friends can initiate a continuous, potentially unending flow of rewards. In alternate embodiments of the invention, it might be possible for a member to pass tips to a friend who is not a member of the system even when the member has not accepted the offer themselves. For example, Person A (i.e., a member of the system) sends a tip to Person B (who is also a member of the system). Person B may forward the tip with or without redeeming the offer to Person C (who is not a member of the system). Person C would then have to become a member to consume or share the tip if they are using the system website, or any other platform other than the mobile application of the present invention. When they consume (i.e. redeem) the tip, Person B would be: 1) remunerated for introducing Person C to the system as a new member, and 2) for Person C redeeming the tip. Person A could be remunerated as well depending on their level.

In further embodiments of the invention, it is possible a financial benefit is only provided to the tip provider and not to the consumer or that financial benefit is only provided to the consumer and not to the tip provider. As a tip provider, an individual may be motivated to send out a tip, however the consumer might only benefit from visibility to the recommendation. Therefore, it is not always necessary to incent the consumer. Additionally, it is not always necessary to financially incent the tip provider. For instance, a business may run a campaign where they pay the system for tip sharing to create an offer that is at retail price. A business pays the system for tip sharing $100 to put out a tip opportunity. Users of the system for tip sharing can see that opportunity and chose to act on it or not. The motivation for some individuals to share the tip without the chance of receiving a reward may be to increase their social visibility, and not to be paid or motivated with some additional tangible benefit.

In one embodiment, the system for tip sharing is made even more appealing by the fact that there are no up-front costs involved in creating a new tip or offer for a business. Incorporating the system for tip sharing into an advertising campaign does not require any increase in the advertising budget as the system for tip sharing only charges commission on successfully completed sales. The commission charged on completed sales can be deducted from the margin percentage set aside for discounts without impacting the marketing campaign budget. After a tip is redeemed and a transaction occurs, the business would need to make a payment to the system for tip sharing. This might occur by withdrawing funds from a prefunded cash account, withdrawing funds from a credit account, through a merchant account, or by sending a bill to the business. In alternative embodiments, the system may charge the business an upfront fee to create and distribute the offer/tip.

Several illustrative examples are provided to explain the use of the system and method for tip sharing. As a first example, an individual receives a tip sent by a friend via the mobile application after which an alert appears on the screen of their mobile device. They open the mobile application and navigate to the new tip. They redeem the tip at a physical world retailer using the mobile application. The physical world retailer fulfills their side of the transaction using a print out of the tip redemption codes. The physical world retailer cashier enters the redemption code and the total cost of the transaction into the mobile application running on the individual's phone, and then hands the mobile phone back to the individual to confirm the details. The individual then shares the tip with three specific friends in his phonebook and also posts the tip to his Twitter® account.

As a second example, an individual who is not yet a registered user of the system for tip sharing receives a tip from a friend via an email or Facebook® message. Using their phone they click on the link in the message which takes them to the mobile website where they register with the system for tip sharing. Next, they download, install, and log into the mobile application. The individual then goes to the physical world retailer and makes the recommended purchase. At the checkout, the physical world retailer fulfills their side of the transaction using point of service (POS) integration whereby a tip redemption code is printed on the individual's receipt. The individual then enters the code from the receipt into the mobile application to claim the tip. The individual sends the tip to two other friends and also publishes the tip on their Facebook® wall. The friend who sent the individual the tip initially receives two sets of commission: one for sending on the tip and the other because they introduced the individual to the system for tip sharing. The person who introduced the physical world retailer to the system for tip sharing also receives a commission payment on the transaction.

As a third illustrative example, an individual purchases a product that has a redemption code printed on it for use with the system for tip sharing. The individual can enter the redemption code into the website or application to claim the tip. After claiming the tip or not, they can recommend the product to several network connections using the website or application. The individual's account on the web site displays all the contacts from the individual's mobile phone as well as all of the individual's network connections from registered social networking technologies. In an alternative embodiment, the consumer may be required to share the tip with their network connections in order to redeem it.

As a fourth illustrative example,—a business registers their offer on the system for tip sharing. In the case of products retailed online, the business will include the URL of the web or app screen that hosts the product or service on offer. An individual who is not yet registered with the system for tip sharing receives a tip via email from a friend that recommends a product or service that can be purchased online. The individual clicks on a link in the email, which takes them directly to the online business's webpage showing the product or service recommended, wherein the business is a registered business user of the system. (It is noted that the individual can also redeem the offer on the system's website or mobile application, though in a less efficient manner.) They add the product to their basket and enter the checkout process. Because the individual has entered the online retailer's website using a referral URL for the system for tip sharing, they are informed that they are eligible for a discount through the system for tip sharing and they are asked to enter their email address as part of the checkout process. After completing the purchase, the individual is informed that they need to register with the system for tip sharing to claim their instant cash back. They follow the link that accompanies the message to the website of the system for tip sharing to complete the registration process, or alternatively they may register on the system from the business's webpage. The individual's account is then instantly credited with their claimed tip, which in this case is a cash back discount. The individual is given the opportunity to pass the tip on to their friends and network connections. In this scenario, if the individual was already registered with the system for tip sharing, then they would only need to enter their email address as part of the checkout process; and, when the purchase was completed they would be informed of the sum of money that had just been credited to their account. The online retailer's website would then display a link offering the individual the opportunity to pass the tip on to their friends and network connections. A link would be displayed to take the individual to the website of the system for tip sharing where they would select which friends and social networks with which to share the tip.

As a fifth illustrative example, an individual redeems a tip by watching a television advertisement and being one of the first 1000 people to enter the redemption code shown in the advertisement into the mobile application for the system for tip sharing. As part of a promotion, a company sets up a tip redemption code that will pay the first 1000 people who enter the code into the system's website or mobile application $50 each, and then the next 10000 people who enter the code would receive $5 each. The code is included in a TV commercial and is set only to become active at a specific time. The company advertises the showing of the advertisement as a special event and the redemption code is displayed at the end of the TV advertisement. After receiving the payment each of these people is then given the option of passing on a tip recommending the promoted product to their friends.

As an extension of this fifth illustrative example, consumers might be presented with the option to help a business by performing an activity, and then receiving a tip (versus receiving the tip by viewing advertisement at a preset time). This might include receiving a tip and/or discount for providing feedback on marketing or branding or performing another related activity to yield a tip. Consumers might be asked to make specific note of certain features of a storefront or store layout or events or items present in a marketing campaign in order to receive a tip.

A reporting system might be implemented which tracks referral effectiveness and is able to keep track of the details of recommendations in order to optimize future marketing campaigns. The system and method for tip sharing utilizes the idea of crowdsourcing marketing by leveraging mass collaboration to achieve certain business goals. The system and method of tip sharing includes the possibility of reporting capabilities back to the business to tailor offers accordingly as well as to optimize marketing strategies. For example, the language contained within a tip, potentially including why the business and offer matter, can be made available to the business.

A tip score (e.g. rating level) can be implemented which provides a rating scheme for businesses, consumers, and tip providers. Businesses might be measured on how timely they are in paying the marketing fee when a tip is redeemed or evaluated against peer businesses that are in the same geographic area or otherwise. A system for feedback may be provided with service level markers to indicate business performance. Likewise, tip providers might be rated on their success rate with tips that are shared being utilized and consumers might be rated on the variety and quantity of tips that are used. An alternative embodiment of this idea might include enabling pre-defined surveys to elicit specific feedback on the transaction experience. This information is fed back to the business and where appropriate is made visible to the consumer.

An application that works through one of the social networking mediums, i.e. Facebook®, may provide a scoreboard showing how other network connections rank with their use of the system of tip sharing. The scoreboard ranking system might include currency levels, status levels, or other related rankings. Currency levels are determined from the amount of discount, cash back, privileges, products, services, or other cash equivalent awards that are received during tip redemption. Different factors might contribute to a user's status level. Some status changes might be permanent boosts to a user's status and some status changes might temporarily boost a user's status. Users might collect medals as rewards for completion of certain tasks and when a certain number of medals are received the user would be promoted to the next status level. A symbol might be added to a user's profile on one of the social networking mediums when a new status level is achieved. When a user starts to make progress toward obtaining a medal, a graphic might appear that previews the medal, shows progress, and informs the user of the steps they need to undertake to complete achieving the next status level. Custom medals or awards might also be created for outstanding or unique users, including but not limited to users that leave a certain balance in the cash account or users that achieve a certain number of transactions.

Key individuals who are prolific and successful in sending recommendations to their network connections might be targeted with exclusive offers or free products or services. These individuals may be given the option to pass these exclusive offers to friends. For example, if a consumer has been very successful in passing bicycle related tips to their connections, a company that manufactures bicycle tires might be enticed to send a free sample of bicycle tires to try out. If the individual likes the tires, then they will be given the option to send a tip related to the tires on to their network of bicycle friends who are avid bike riders, kicking off a new cycle of recommendation.

A section within the web site or mobile application might include an organizational method to keep track of favorite businesses. Favorites might be organized by geography, type of business (i.e. natural and organic food stores) or any other method.

Businesses are provided with tools to tailor the attributes of tips to capitalize on sales psychology. Different embodiments of the invention might include offers which can be limited to a set time, a finite number of offer redemptions, offers which have a rapidly declining value or offers which provide an increasing discount for a large number of customers agree to purchase. One special type of offer leverages the group buying dynamic by offering a variable discount depending on the number of people who join the deal within a fixed period of time. Deals get sweeter as more people join. For example, a first offer might be such that if some predetermined amount of people join this deal they get a certain rebate, a second offer might be such that if some additional predetermined amount of people join this deal they all get the rebate of the first offer plus a bonus which might include a further discount, an additional discount on an alternative product, or some additional product or service bonus. A third even greater offer might be such that if an even greater predetermined amount of people join this deal they all get the rebate of the second offer plus an additional bonus which might include an even further discount, a further discount on an alternate product or products, or some additional product or service bonus. Members who join a deal are provided further motivation to pass the recommendation and discount on to their friends and contacts.

A business participating in the system for tip sharing can create a special class of tips that only become visible to a customer after they have either tipped the business or redeemed a tip at the business. This special class of tips, called golden tips, can only be redeemed once per member and must offer a minimum discount and/or a special boost to the tip provider. Golden tips can be distributed by a random lottery system with some level of uniqueness of availability.

A consumer using the tip sharing might be given the option to define, or propose, a deal. A consumer might suggest an offer to a business that would then need to accept the offer before it is available in the marketplace. The business then decides if it wants to take up the suggestion, and if so make the suggestion into a valid tip.

Alternatively, a deal might be suggested in the marketplace by a consumer and evaluated against a business profile for probability of being accepted. Potentially interested consumers can pile on to a deal before they are accepted by the business. Piled on proposed deals motivate the business further by gauging buying interest. One embodiment of this concept might collect advanced monies as a purchase or commitment and a good faith sign that the consumer has firm intent to purchase; this might be a percent of the tip value up to the full amount. Alternative embodiments of this concept would require no monetary commitment.

Some illustrative examples of the “define a deal” option are provided. A consumer might define a deal for a coffee and biscotti for $2.00 on Thursday mornings between 10 am and noon. For the deal to be officially defined, the consumer would pay either the full price of the deal (here $2.00) or a percent of the offer price in order to give commitment to the business and to ensure a payment method or sufficient financial backing with deposits in the consumer's account that is used with the system for tip sharing to cover the transaction. If proof of sufficient funds is provided, the system for tip sharing might have the option to hold those funds until the deal is decided with some time expiration.

In another example of “define a deal”, the consumer could define a deal and guarantee a certain number of sales. In this scenario, the system for tip sharing is given the option to take full payment or a percent of the deal value in order for the business to have confidence that there is serious interest in a purchase or sale. The individual who defined the deal would be given an opportunity to resell the deal in the marketplace at a price and with terms that are agreed to by the source business, to the individual's network. Once the deal is accepted, the full payment balance is executed. The “define a deal” platform enables members to define and sell deals in exchange for revenue. The system for tip sharing creates a platform that enables broader distribution of the defined deal at its discretion and has the ability to take a transaction fee.

In another example of “define a deal”, a consumer states what they are looking for (i.e. a specific product or service) without a price. The business responds with what they can provide at what price. The consumer is given the option to accept, counter, or decline. Upon offer acceptance, payment exchanges hands. Further embodiments of the “define a deal” model are feasible and the examples stated here do not limit the full scope of the idea. (See FIG. 13 for all the examples).

A user-friendly recommendation sharing experience is provided that makes it easy for all types of people to send and receive recommendations. The system for tip sharing is designed to provide a low barrier to entry, ease of use, and an intuitive first use experience. Although the system integrates with social networking platforms it is also an attractive proposition for people who do not have the time or interest to engage in online social networking.

In one embodiment of the invention, the system for tip sharing is accomplished via an application on a smart phone or other computing device. The smart phone or other computing device could be an iPhone, a Droid, or other equivalent device that would allow the use of an application for tip sharing. In alternate embodiments of the invention, the system for tip sharing is accomplished via a website dedicated to management of tips and tip sharing or via an automated telephone service.

The platform used to redeem the tip is dependent on the type of tip that is being shared. A tip from a physical world retailer would typically be redeemed via the mobile application or an automated telephone service. A tip attached to a product by the product manufacturer could be redeemed either via the mobile app, the web site, or the automated telephone service. A tip from an online retailer would typically be redeemed via the website. A tip for performing an activity like watching or reading an advertisement could be redeemed via the mobile application or website. All of these tip redemptions use the same core transaction and remuneration system.

Vendor interactions with the tip sharing process do not depend on the type of tip being shared. A small business may print tip redemption codes (in numerical, QR code, alphanumeric, barcode, or equivalent) and cross them off the list every time they use one to redeem a customer's tip. A large business may integrate the generation of redemption codes into their point of sale (POS) system so that redemption codes can be printed on each receipt. RFID, near field communication (NFC), or other related formats could be used in a smartphone or other mobile device to process tips in a POS system. The consumer would place their phone in proximity to the NFC transmitter that is attached to the POS system to redeem the tip. Another method for POS integration might include a POS system which displays a redemption code on the POS screen that the cashier enters into the consumer's phone running the mobile application for the system for tip sharing. POS can also be used to cross sell products by displaying related offers at the time of purchase or offering online deals for a purchase at a physical world retailer. A product manufacturer may use a file containing hundreds of thousands of tip redemption codes to print a unique code on each product they manufacture at the factory. A single tip redemption code that is included in a television advertisement may enable a first group of people who enter the code into the mobile application or website to receive a payment. A small business may use a mobile application intended for businesses to generate redemption codes on the fly in response to each customer redemption. All of these examples use the same transaction and remuneration system, even though the means by which they interact with the system are very different.

Consumers may set up accounts within the system for tip sharing. A specific credit card or other payment method could be linked to the system for tip sharing as a way to reconcile that a transaction actually occurred. A tip might be redeemed and paid for using a credit card on file. The system for tip sharing could act as an interface between the various payment methods, the tip, geo-location, and a transaction validation method (QR code, NFC, or other). The interface would provide an authentication method to confirm that the transaction actually occurred. The system for tip sharing may be able to link different financial information in a single place, with various payment methods that help facilitate tip transaction authentication. Currency tracking would be highly implemental in this process. Consumers might have positive balances if they have redeemed tips or tipped others and not withdrawn the entire amount. Businesses might also set up accounts that were seeded for tip commissions. By having both consumer accounts and business accounts, we can create a mechanism to execute a payment transaction.

A payment transaction might transfer funds from the consumer's account and put funds directly into the business's account as a payment method for goods or services related to a tip transaction. In a refund scenario, funds could be refunded from the business's account to the customer's account and any funds that were received by the consumer as part of a rebate would be returned to the business's account.

The system of tip sharing is capable of integration with various social networking media including but not limited to Twitter®, Facebook®, Blogger®, Tumblr®, Foursquare®, Gowalla®, and various other applications. When sending a tip or recommendation to friends, members may be given the option to share the tip over a social networking medium. The first time a member chooses to share a tip in this way, they are required to authenticate the system of tip sharing with their social networking account. Users of the system for tip sharing and a social networking medium are able to easily post tips directly from the application or website associated with the system of tip sharing. Within the system for tip sharing, a tip consists of a short string of text (for example why the member likes the specific business, product, or service) and a link, and is thus ideally suited to sharing via various social networking mediums.

The Facebook® application specific to the system of tip sharing enables Facebook® users to send, receive and discuss tips with their friends. To provide a tip, the member is asked to select friends from their Facebook® address book and/or Facebook® groups. The tip is then sent to their friends as a Facebook® message. An option to post the tip on their wall is provided. The application specific to the system of tip sharing provides an aggregate view of all tips sent and received along with all associated discussion. A marketing campaign tied to a tip might provide additional incentives for providing positive feedback (i.e. in Facebook® indicating “like”) towards a tip or a business. In order to gain the maximum benefit from a tip of this nature, the user is incentivized to publicly share their approval of the company. The additional benefit could be embedded in the original tip or added as a separate tip “top-up” that derives direct monetary gain and/or additional benefits. Tips can simply be activities that can be executed in exchange for some type of reward, value (ex: direct monetary gain and/or additional benefits).

The system for tip sharing will be capable of integration with social location based services including but not limited to Foursquare® and Gowalla®. After redeeming a physical world tip, users will be offered the option of checking in at the business and posting details of the tip. This tip with them become visible to other users of social location based services, whether or not they are already members of the system for tip sharing. Additionally the system for tip sharing will offer the option to automatically receive new tips from businesses the user frequents. The mobile application of the system for tip sharing sends geo-location data to the system for tip sharing. This allows for tailoring of special offers presented in the mobile application to the precise physical location of a user. This geo-location data can be used to build up a picture of the customer's habitual locations. When the customer visits the website of the system for tip sharing, these habitual locations can then be used to micro-localize the special offers.

Additional embodiments of the invention might include sharing tips automatically. The number of tips any user can receive automatically each month might be capped at a low level to prevent spamming. Examples of cases where this would be appropriate might include if a certain number of a user's friends frequent a location within a geographical proximity of one of the user's habitual locations. If the user has not already reached a monthly automatic tip ceiling, and they have not been sent the tip by one of their friends previously, they will then receive an automatic tip informing them of the offer.

In one embodiment, customers who have made more than a minimum number of transactions will be invited to write a business review following a transaction. Businesses may be allowed to remove one review after a certain number of transactions are processed. In a further embodiment of the invention, businesses that participate in the tip sharing system may be provided with customer feedback and demographics. After a given number of tip redemptions have been made, private anonym zed statistics that detail customer demographics and give comparisons with other businesses in the same business sector and/or geographic location may be provided.

In another embodiment, the business would pay a fee for contracting the system to share tips with system members whom the business has no direct connection with. For a sum of money, the system would distribute a business's tip with a targeted segment of members. For example, a bicycle company could contract to share one of their tips with the top 10,000 system members who redeem and/or share bicycle related tips.

These and other features of the present invention will become readily apparent upon further review of the following specification and drawings.

### BRIEF DESCRIPTION OF THE DRAWINGS

The present invention is illustrated by way of example and not limited in the accompanying figures in which like reference numerals indicate similar elements and in which:

FIG. 1 illustrates a flow chart implementation of the interactions between individuals in accordance with the preferred embodiment of the invention.

FIG. 2 illustrates a flow chart implementation of the cycle of tip sharing in accordance with the present invention.

FIG. 3 illustrates a flow chart implementation of the remuneration system in accordance with the preferred embodiment of the invention.

FIG. 4 illustrates a flow chart implementation of an alternate embodiment of the remuneration system in accordance with the present invention.

FIG. 5 illustrates a flow chart implementation of one special type of tip that might be offered in accordance with the present invention.

FIG. 6 illustrates a flow chart implementation of the geo-location aspect of the system for tip sharing in accordance with the present invention.

FIG. 7 illustrates an example screen shot of one embodiment of the mobile application which details a balance sheet to keep track of currency levels associated with present invention.

FIG. 8 illustrates an example screen shot of one embodiment of the mobile application which indicates a tip was successfully shared with network connections.

FIG. 9 illustrates a block diagram of how information passes from a server to individuals in a preferred embodiment of the present invention.

FIG. 10 is an illustration of the website system in accordance with one embodiment of the present invention.

FIG. 11 is an illustration of the user's mobile device installed with the computer product software application of the present invention.

FIG. 12 is an illustration of the kiosk system in accordance with one embodiment of the present invention.

FIG. 13 is a block diagram to illustrating the various methods of a user “defining a deal” to a business.

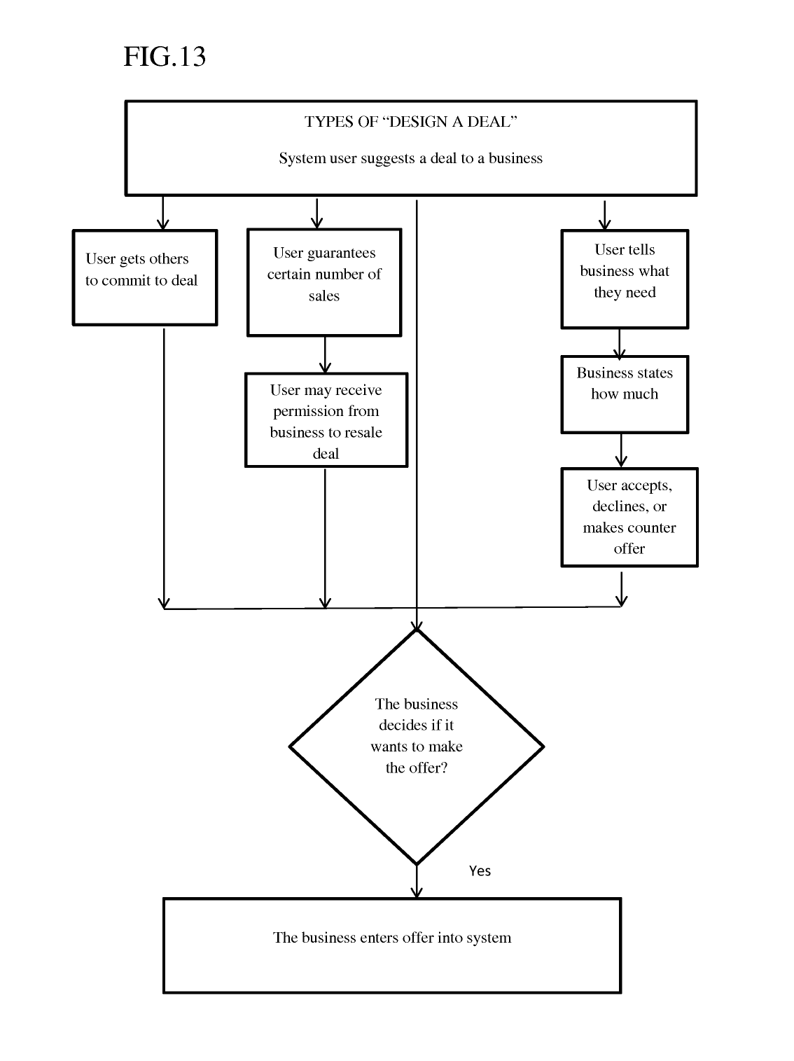

### DETAILED DESCRIPTION OF THE INVENTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

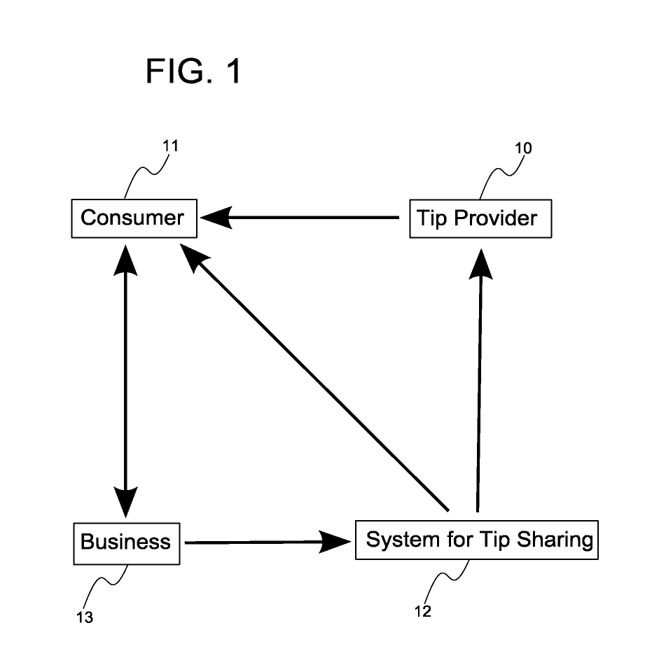

Illustrated in FIGS. 1-6 is a system and method for tip sharing embodying the present invention, which is suitable for use as a means for making recommendations for purchasing goods and/or services to individual members of a user's social network. In FIG. 1, which illustrates the core transaction and remuneration system in accordance with the present invention, a tip provider 10 identifies and recommends a product, company, service, or activity to one or more other people (e.g. consumer 11). The tip identifier identifies the tip from various sources, such as: it was shared with them from a non-system user, or system user; they viewed it the tip directory of the system's website or on their system's mobile application; they saw it advertised (e.g. newspaper, T.V., sticker in shop window, print catalogue, menu, email, etc.); they viewed it on a business's website or mobile application; and they viewed it on a social service like Twitter®, Pinterest®, etc. This recommendation is communicated via the system for tip sharing 12 that would publish the recommendation, and/or forward this recommendation on behalf of the tip provider, and/or provide the tip provider with a URL or Tip ID allowing the tip provider to communicate the tip themselves. The communication mediums used can include email, short message service (SMS), social network personal message, social network public posting, blog post, via a software application on a mobile device, a website on a computer, or via a computer program at a kiosk provided by the system for tip sharing or any other related communication medium. The recommendation might include an incentive that the person receiving the recommendation (e.g. consumer 11) can claim when they either purchase the recommended product or service, purchase from the recommended business, or complete the recommended activity. The incentive can take the form of a payment, a discount, a benefit, a product or service, or any other related equivalent. It is noted that each tip can have multiple tip providers, and the chain of associations between the business's offer, each tip provider and the consumer who responds to that particular tip provider is determined and stored by the system's processor.

In FIG. 1, a next step involves a consumer 11 receiving the recommendation from the tip provider 10. The consumer 11 uses the recommendation and claims the associated incentive by, depending on the nature of the recommendation, either purchasing the recommended product or service over the network on the system's website or the business's website, making a purchase at the recommended business's physical location, or completing the recommended activity.

Examples of activities comprise: a) a consumer watching an advertisement, and receiving a Tip redemption code at the end, then using their system account to input the code and redeem the incentive; b) a consumer taking a photo and sending it to a business, who rewards the consumer by sending them a tip redemption code; and c) a consumer physically attending a business's event (e.g. product launch), and redeeming the incentive automatically by the system detecting the consumer's GPS coordinates, and wirelessly transmitting the incentive to the consumer's mobile application/device.

In FIG. 1, a next step involves the business 13 contracts with the system for tip sharing 12. The business 13 might be a manufacturer of a product, a retailer, individuals selling items, a service provider, or any entity that would like to incentivize people to undertake any type of activity.

In FIG. 1, a next step involves the consumer 11 receiving the incentive from either the business 13 or from the system of tip sharing 12 in the form of a payment, a discount, a benefit, a product or service, or any other related equivalent. A next step involves the system for tip sharing 12 sending a payment or cash equivalent that can be redeemed for products or services to the tip provider 10.

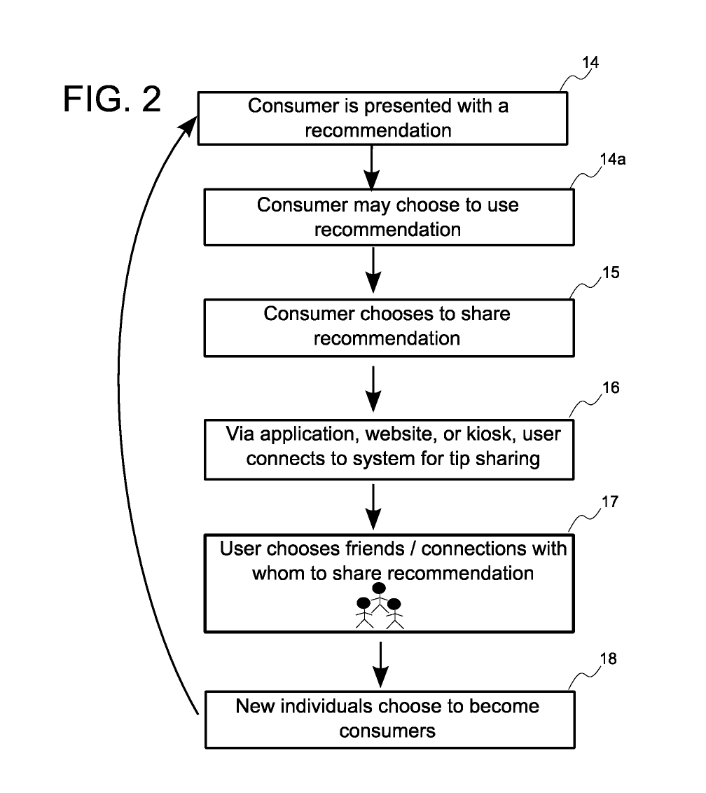

In FIG. 2, consumer 11 who received a recommendation is presented with the opportunity to use the recommendation and/or pass the recommendation on to other people in steps 14 and 14a. The consumer need not redeem the offer (i.e. use the recommendation) in order to receive a bonus or incentive. He may be rewarded for sharing the offer with another entity (business or person). This process starts after either consumer 11 receives a recommendation or consumer 11 receives an incentive from redeeming a recommendation or the consumer views a recommendation (in any format/place/medium) and decides to pass the recommendation on to others. The consumer 11 is presented with the opportunity to recommend to other people the product or service they have just purchased, the company they have just purchased from, or the activity they have just completed. The consumer 11 is given the opportunity to make the recommendation using an application, website, or kiosk that connects to the system for tip sharing. This application, website or kiosk can be provided by either: a) the system for tip sharing 12; or b) the business 13 with which consumer 11 has just interacted. For example to the latter, the consumer can pass a recommendation to friends, or publish a recommendation on a public forum direct from a business's website (or store in the case of a kiosk). In one embodiment, on a product page on a ecommerce retailer's website there would be a “Tip” button or similar link. When the consumer presses this button, an online form would appear allowing the consumer to send and/or publish the tip/offer on the system without leaving the retailer's webpage. If the consumer had not logged into the system previously, they would be required to enter their system credentials into this embedded form before they can share/publish the tip/offer.

In steps 15 and 16 of FIG. 2, the consumer 11 uses the application, website, or kiosk to recommend the product or service they have just purchased, the company they have just purchased from, or the activity they have just completed to other people. On behalf of consumer 11, the system for tip sharing 12 publishes the recommendation and/or forwards the recommendation to other people via one or more of the following mediums: email, SMS, social network personal message, social network public posting, blog post, an application or website or any other appropriate communication medium in step 17. The consumer 11 selects which of their contacts to share the tip with. (i.e. the consumers are now also a tip provider.) The contacts are chosen from an aggregated list stored in the consumer's account on the system database, comprising: a) contacts in their phone address book; b) contacts in their social networks address book; c) contacts they have directly entered into their system account; and d) other system users whom the consumer has previously exchanged tips with. Consumer 11 may also, or alternatively, select their social networks and web services they wish to publish the tip on. Consumer 11 may also have the option of sharing the tip manually using a URL and/or a TipID (unique tip identifier) assigned by the system.

The recommendation includes an incentive that the person receiving the recommendation can claim when they either purchase the recommended product or service, purchase from the recommended business, or complete the recommended activity. The incentive can take the form of a payment, a discount, a benefit, or a product or service. The incentive can either be the same or different from the incentive that consumer 11 receives from tip provider 10. In step 18, some or all of the friends/connections who read the consumer's recommendation choose to use the recommendation. The process continues with each person who chooses to use the recommendation playing the role of consumer 11 as the process continues.

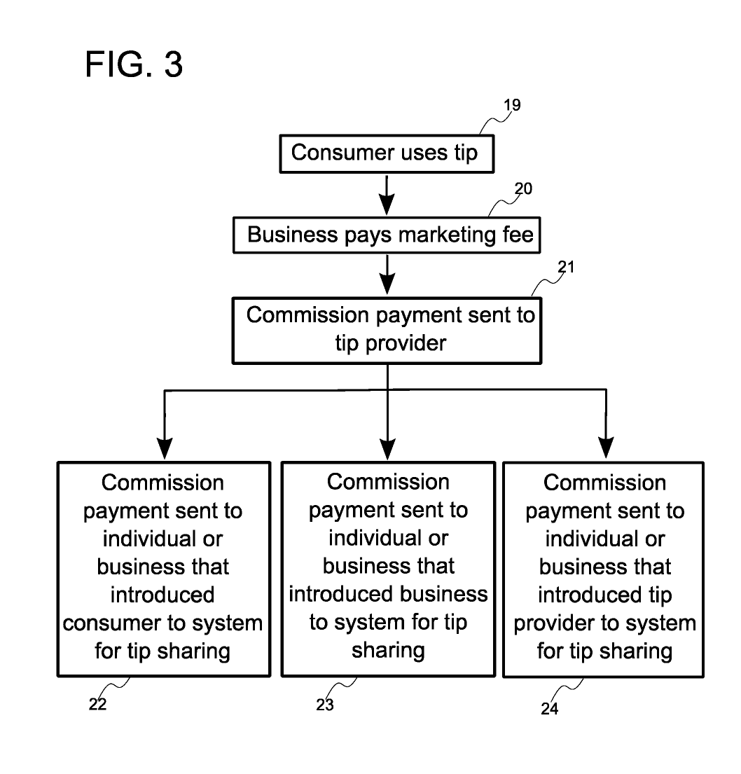

In FIG. 3, a recommendation is used and an incentive is claimed in step 19, business 13 pays a marketing fee in step 20, commission is paid in step 21 to the businesses and individuals who introduced the three parties in the transaction to the system for tip sharing. On successful completion of a brokered recommendation transaction, the system for tip sharing 12 pays commission to the individual or business who introduced business 13 in step 23, tip provider 10 in step 24, and consumer 11 in step 22 to originally register with the system for tip sharing 12. The individual or business who introduced tip provider 10 or consumer is the party who either gave tip provider 10 or consumer 11 the first brokered recommendation that they successfully claimed or the individual that introduced tip provider 10 to register with the system for tip sharing 12. Likewise, the individual or business who introduced business 13 to the system for tip sharing 12 is the party who introduced and got business 13 to originally register with the system for tip sharing 12.

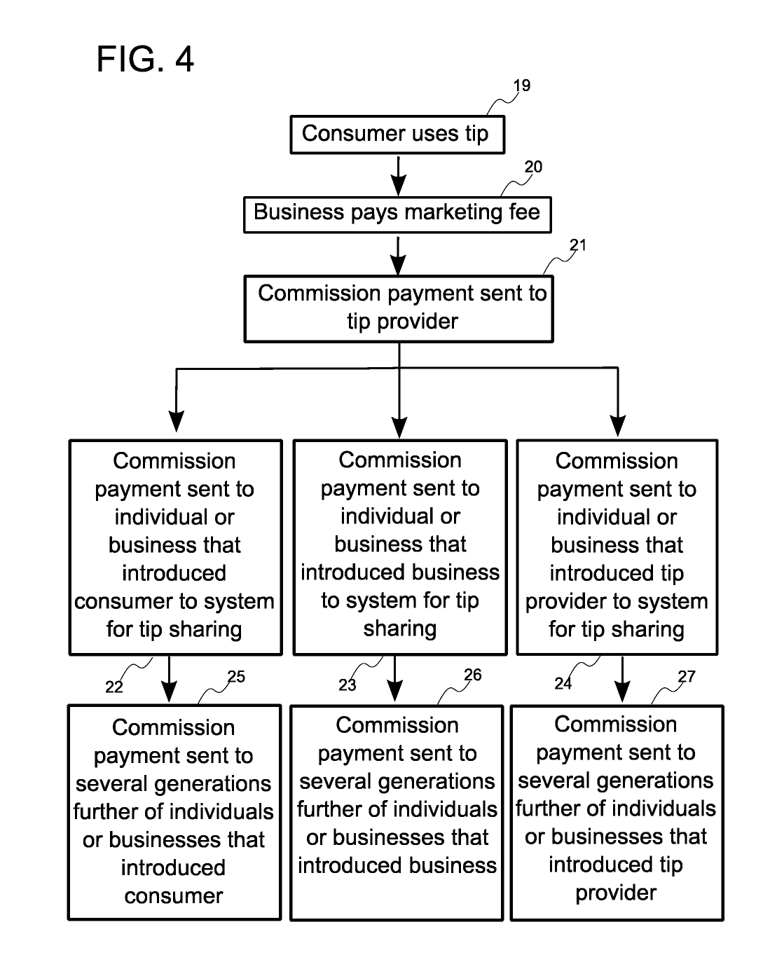

In FIG. 4, after a tip is used and a transaction is made, commission is paid to several generations of the companies and individuals who introduced tip provider 10 in step 27, consumer 11 in step 25, and business 13 in step 26.

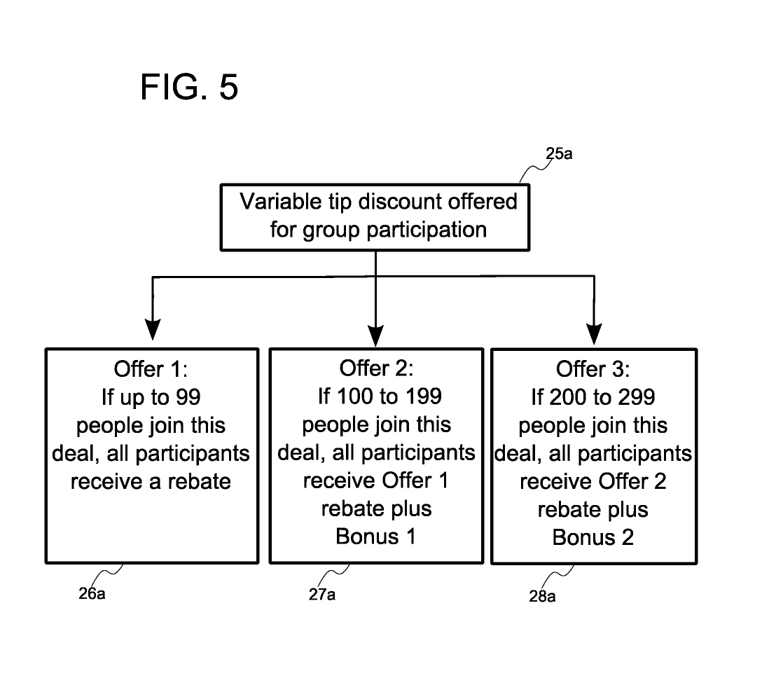

In FIG. 5, the concept of a special type of deal which leverages the group buying dynamic is illustrated. A variable tip discount 25a is offered depending on the number of people who join the deal within a fixed period of time. Deals get sweeter as more people join. For example, a first offer 26a might be such that if some predetermined amount of people join this deal they get a certain rebate, a second offer 27a might be such that if some additional predetermined amount of people join this deal they all get the rebate of the first offer plus a bonus which might include a further discount, an additional discount on an alternative product, or some additional product or service bonus. A third even greater offer 28a might be such that if an even greater predetermined amount of people join this deal they all get the rebate of the second offer plus an additional bonus which might include an even further discount, a further discount on an alternate product or products, or some additional product or service bonus. Members who join a deal are provided further motivation to pass the recommendation and discount on to their friends and contacts.

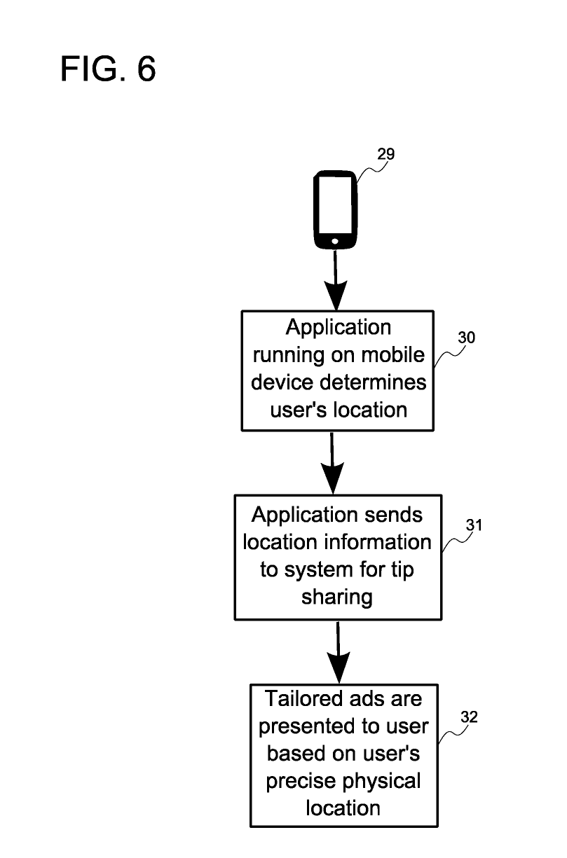

In FIG. 6, website micro-localization is described, comprising for example, geo-location, user preference, habits, and attributes captured by the system from the user's electronic computing device. Geo-location information is provided to a web site using an application running on mobile phone 29. The geo-location information is sent to the system for tip sharing 12 which uses the information to customize ads for that geographic location. The precise geo-location of an individual can be determined from a mobile device 29 in step 30 and passed to the system for tip sharing in step 31 to customize ads in a website on user's computer in step 32. Location data from the user's phone is used to micro-localize content on a different platform, i.e. the web browser of the user's computer.

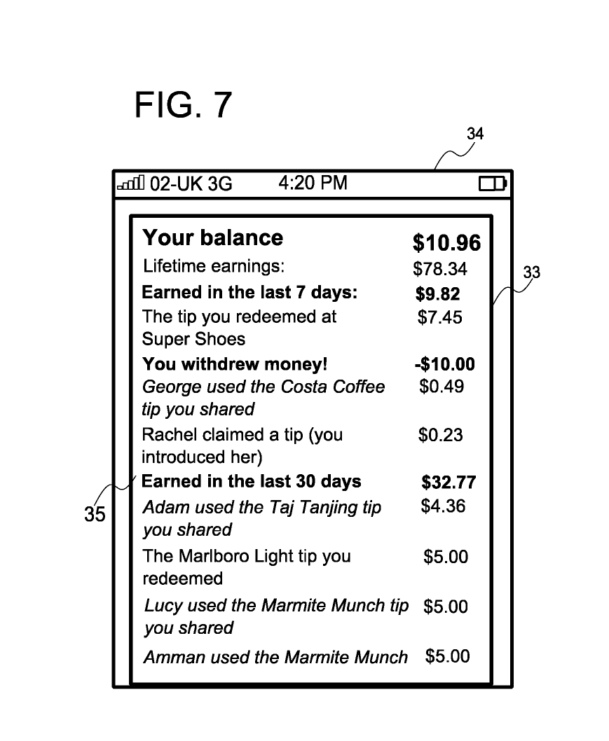

In FIG. 7, an example screen shot of one embodiment of currency tracking in the mobile application of the system for tip sharing is shown. A record is kept of payments for all transactions, including but not limited to tips redeemed at various businesses, payments for tips shared with connections, and withdrawals. Mobile device screen 34 contains balance sheet 33 which details payments that have been earned 35, amounts that have been withdrawn, and payments from tips that have been redeemed by existing users or for new members that have joined. The system for tip sharing 12 may be used like a bank account as a payment mechanism.

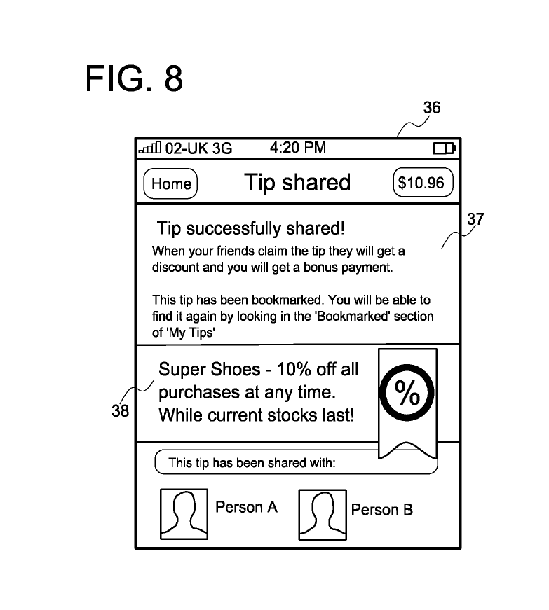

In FIG. 8 shows an example screen shot of one embodiment of the mobile application which indicates a tip was successfully shared with network connections. Mobile device screen 36 contains detail explaining that a tip including a rebate percentage 38 has been successfully shared with a group of network connections. Section 37 details that when friends claim the tip they will get a discount and the person passing the tip will get a bonus payment.

### Computer Program Product

The computing device of the present invention (e.g. smartphone, laptop, kiosk, etc.) may comprise a native application, a web application, or a widget type application to carry out the methods of the present invention. In a preferred embodiment, a native application is installed on the device, wherein it is either pre-installed on the device or it is downloaded from the Internet. It may be written in a language to run on a variety of different types of devices; or it may be written in a device-specific computer programming language for a specific type of device. In another embodiment, a web application resides on the system server 39 and is accessed via the network 40. It performs basically all the same task as a native application, usually by downloading part of the application to the device for local processing each time it is used. The web application software is written as Web pages in HTML and CSS or other language serving the same purpose, with the interactive parts in Javascript or other language serving the same purpose. Or the application can comprise a widget as a packaged/downloadable/installable web application; making it more like a traditional application than a web application; but like a web application uses HTML/CSS/JavaScript and access to the Internet.

### System Architecture

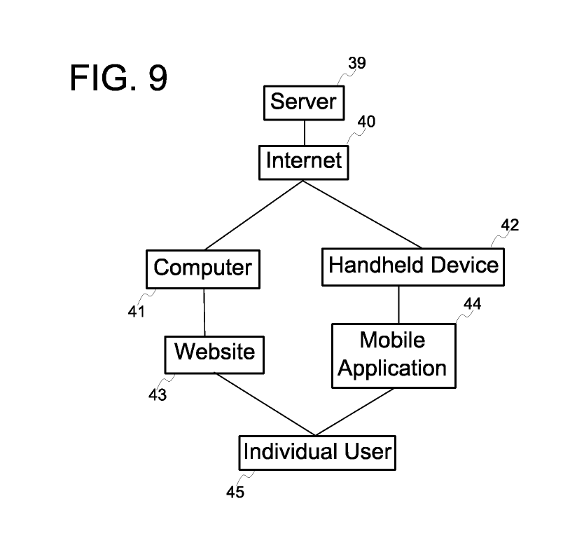

In FIG. 9 illustrates a block diagram of how information passes from a server to individuals in a preferred embodiment of the present invention. Information passes from server 39 over internet 40 to either computer 41 which passes information to website 43, or to a kiosk at a public venue, or to handheld device 42 which passes information to a mobile application 44 and is then readable by individual user 45. It is noted, though, that these two streams will merge in an alternative embodiment, wherein the system is device agnostic.

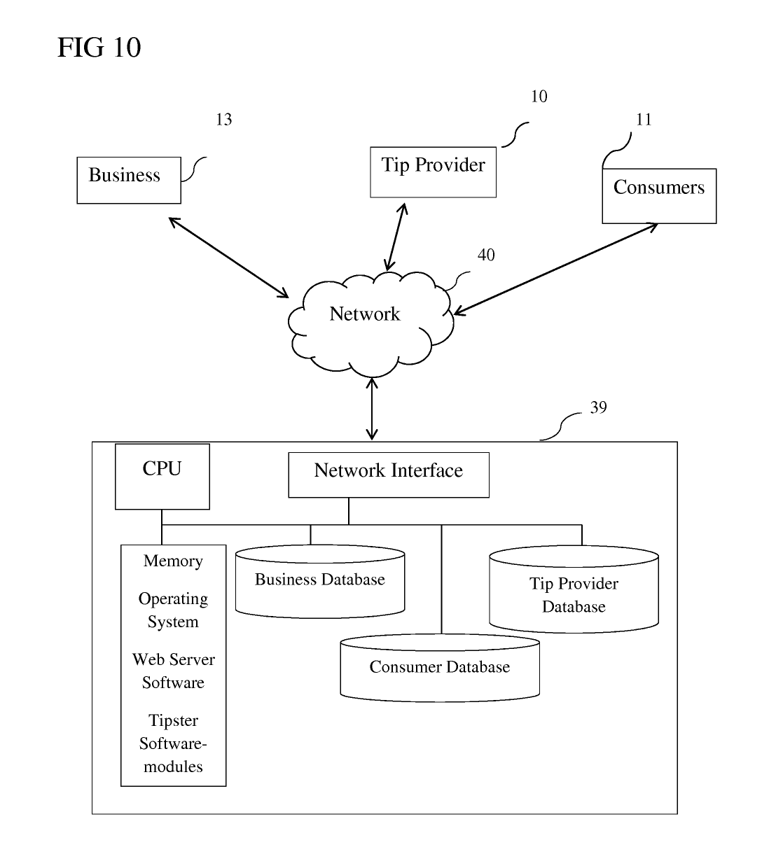

FIG. 10 is a further illustration for the networked computer system 41 that receives a promotional offer/tip from a business 13, forwards the tip to a tip provider 10, and processes the tip by a consumer 11. The System of the present invention comprises the following components. A Network (e.g. Internet) 40 wherein the term “network” is used to describe any public network such as the Internet or World Wide Web or any public or private network as may be developed in the future which provides a similar service as the present Internet. A system server 39 comprising: a network interface (e.g. network card) for connecting to the computer network 40, a random access memory (RAM) for program execution, a hard disc for program storage, central processing unit (CPU) which tracks and calculates the promotional data and payments, and a system databases comprising records for businesses, tip providers, and consumers activity and information. The system also comprises web server software to execute all aspects of the present invention.

The CPU tracks all activity of system users (e.g. businesses providing offers, tip providers, and consumers), and stores the activity in the respective database. For example, the system will automatically determine who the tip provider is when a consumer redeems an offer. In the case of a direct tip provider-to-consumer recommendation, the system will have stored a record on the tip provider's database. And in the case of tips published on public forums like Twitter®, the tip link will include a unique identifier the identifies who published the tip.

The CPU also calculates when and the amount of payment, or other incentive, is due to or from the business, and tip provider/consumer. And the CPU processes the payments to and from the business's and tip provider's/consumer's online system financial account, such as a system credit/debit account, and/or the CPU processes payments to and from a third party account (e.g. PayPal®). For example as per FIG. 3, the CPU calculates and processes the amount of the marketing fee a business needs to pay when an offer is redeemed, and transmits notification to the business of the payment. The business then sends payment to the system via their PayPal® account, and the CPU credits the business's system account with the payment. Concurrently, the CPU credits the tip provider's/consumer's system account with the commission, or transmits the commission amount to the designated third party account (e.g. the tip provider's/consumer's PayPal® account). The CPU also calculates the tip provider's “score” and the rating scheme for businesses, consumers, and tip providers.

A User computing device (e.g. business's, tip provider's, or consumer's) comprises an electronic communications device with web browser capabilities, such as a mobile communications device, a desktop, a laptop, a netbook, and a mobile phone device (i.e. smartphone), etc. The User computing device is configured to communicate with the System server via the Internet to enable Users to access the tip providing modules of the present invention. The User's computing device may connect to the network via a variety of methods such as a phone modem, wireless (cellular, satellite, microwave, infrared, radio, etc.) network, Local Area Network (LAN), Wide Area Network (WAN), or any such means as necessary to communicate to a server computer connected directly or indirectly to the network (i.e. the Internet).

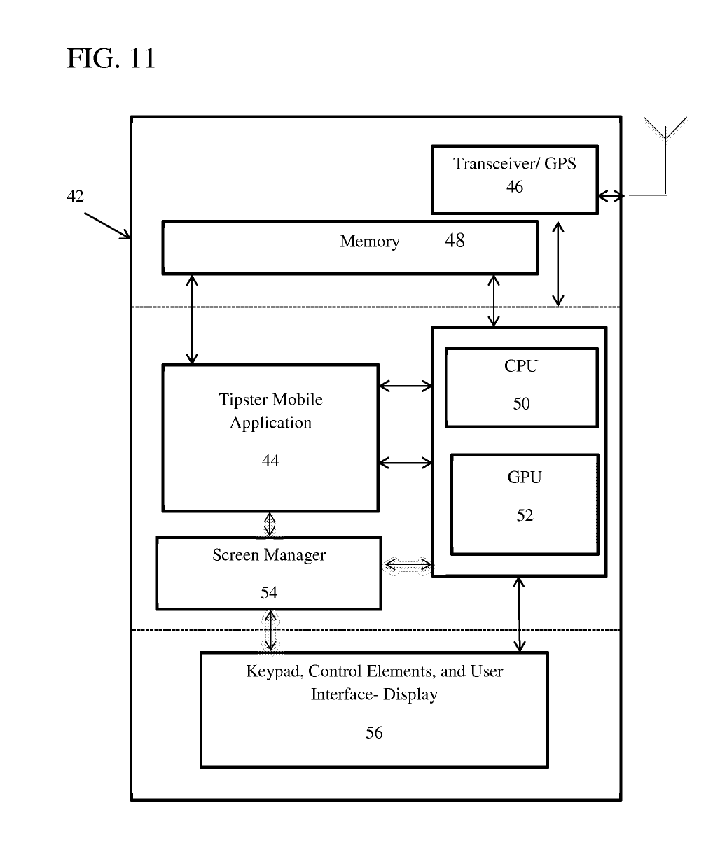

FIG. 11 is an illustration of a mobile device with the computer program product 44 of the present invention installed that is installed on the electronic computing device that primarily comprises: a central processing unit (CPU) 50; a User interface with keystroke or touchscreen data input keypad 56; memory 48 such as random access memory (RAM), read only memory (ROM), nonvolatile memory such as EPROM or EEROM, flash memory or hard drive memory; a transceiver 46 functionality connected to an antenna to receive and transmit data in a wireless network; location detection functionality (e.g. GPS) (not shown) and system registration, tip providing and payment modules/software 44 of the present invention, otherwise known as the “Tipster Mobile Application”.

The transceiver may operate according to standards commonly known in the art by the skilled practitioner for voice or data network communications. Voice networks comprise Global System of Mobile (GSM) communication system, a Code Division, Multiple Access (CDMA system), and a Universal Mobile Telecommunications System (UMTS). Data networks comprise General Packet Radio Service (GPRS), third-generation (3G) and fourth generation (4G) mobile, High Speed Download Packet Access (HSDPA), High Speed Uplink Packet Access (HSUPA), Worldwide Interoperability for Microwave Access (WiMAX), or any other mean of transmitting data wirelessly.

In a preferred embodiment, the transceiver further comprises location detection functionality, such as global positioning system (GPS) receiver, or is GPS enabled with software and hardware, in order to calculate the geographic location (e.g., latitude and longitude coordinates) of the mobile device and transmit the information to the mobile network server for access by the system server 39, or directly to the system server 39 or to the computer program product loaded onto the mobile device. GPS technology and associated methods to calculate and transmit GPS-based geographic location information from a mobile device to the mobile network server and/or system server and/or for use by on the mobile device are known to persons skilled in the relevant art.

The mobile device may further comprise: a graphical processing unit (GPU) 52 configured to perform various tasks related to displaying the promotional data at a set frame rate; a power supply with a rechargeable battery pack; a camera; and a microphone.

The mobile device further comprises a screen manager 54 with a software or firmware process that manages content displayed on the graphical user interface (GUI) 56. In one embodiment, the screen manager monitors and controls the physical location and type of promotional data displayed on the GUI 56. The screen manager also alters or updates the location of promotional data on the GUI responsive to input from the central processing unit 50 and the graphical processing unit 52, to modify the GUI appearance. The screen manager also monitors and controls the promotional data brightness, opacity, and color saturation and transmits control signals to the central processor and the graphical processing unit to modify each.

It will be appreciated by one skilled in the art that the mobile device system described above is illustrative and that variations modifications are possible.

Additionally, the Tipster modules of the present invention installed on the system server and/or mobile device comprise:
a) Registration on the system by:
   i) The business that is making the offer, contact information, login/password, and the account to bill marketing fee when offer is redeemed by system tip provider/consumer;
   ii) Tip provider's contact information, login/password, list of contacts (or connection to e.g. Facebook®), and the account to transmit bonuses to (e.g. PayPal®); and,
   iii) Consumer's redeeming offer, their contact information, and the identity of the tip provider;
b) Creation by a business system user of their advertisement, and transmission to system users or URL links to the system from the business's website during product purchase;
c) Tip provider designating which offers to share with which of their contacts;
d) The system calculating and processing payments from businesses for marketing fees, and bonuses/commissions to tip providers;
e) The system calculating user's “scores” comprising rating schemes for businesses, consumers, and tip providers; and,
f) Determining location detection functionality attributes of the user's device, such as GPS location of tip providers/consumers using GPS enabled mobile devices, and the system forwarding offers that are specific to their current location or user's attributes.

Furthermore, the computer program modules comprise code for when users register on the System, via an application installed on a mobile device, kiosk, or computer, or via a website. The businesses, tip providers, and consumers may be required to provide specific types of information. For example, businesses need to provide contact information, login/password, and the account to bill marketing fees when their offer is redeemed by another System user. A tip provider would disclose their contact information, login/password, list of contacts (or connection to e.g. Facebook®), and the account to transmit bonuses/commissions to (e.g. PayPal®). And consumers would provide contact information and the tip provider who transmitted said offer to said consumer.

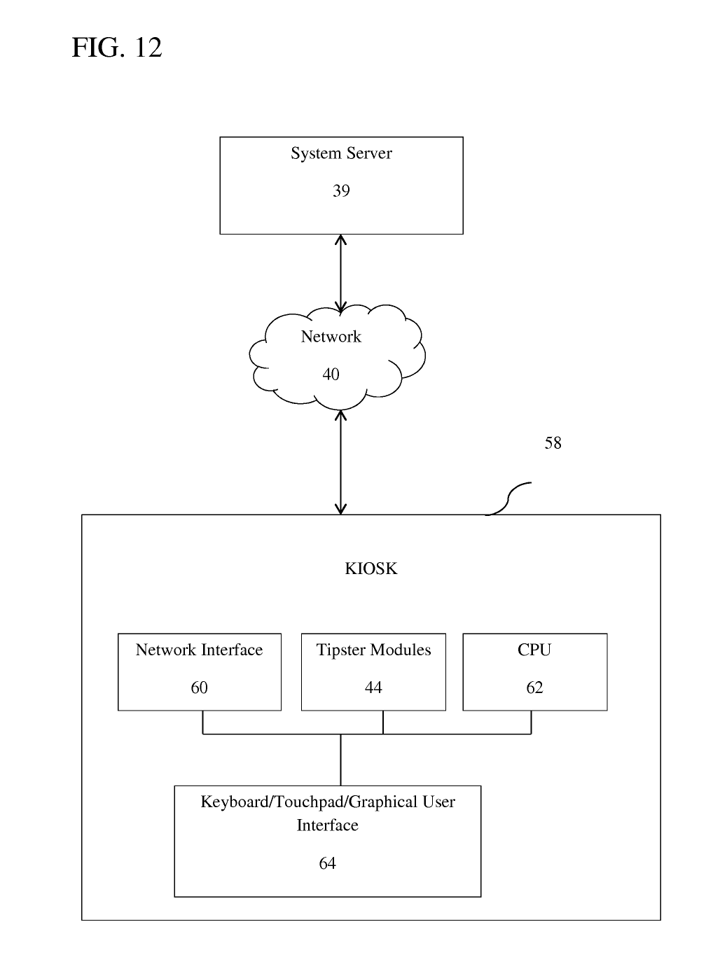

FIG. 12 is an illustration of a Kiosk with Internet access for use by consumer 11, such as a shopper within a mall. The Kiosk computer 58 comprises a network interface 60, a central on processing unit 62, a screen 64 comprising a graphical user interface responsive to a keyboard, or to the consumer's touch. The Kiosk further comprises computer memory for storing business promotions downloaded by the tip provider 10. In a preferred embodiment, the promotions are downloaded via an Internet connection 40 directly with the system server 39, or via an intermediate server (e.g. see U.S. Pat. No. 6,286,029 the teachings of which are herein incorporated by reference). Alternatively, the Kiosk computer may provide direct Internet access to the consumer wherein promotional data may be viewed by the consumer navigating to a particular website.

### EXEMPLIFICATIONS

### Exemplifications of Three Types of Tip Transactions

### 1. Online Purchase

Online purchase tip transactions are processed in an entirely automated manner. A method comprises an offer with a URL directly linking to a product or business web page or mobile application. The URL also encodes the TipID and the identity of the tip provider. After the customer has completed the online purchase they are either:
a) Given a redemption URL to click on that contains a single use tip redemption code. They click on this URL to be taken to the system website where they finish redeeming the tip. The redemption code encoded in the redemption URL is generated by the online business sending the system the TipID, the identity of the tip provider and (if required) the total cost of the transaction; or.
b) The redemption is processed in the background as part of the transaction, and when the customer completes the purchase they are informed that the tip has been successfully redeemed (without leaving the business's website or app).

The customer is then given the opportunity to pass the tip on to their friends electronic communication (e.g. Twitter®, Facebook®, Email, MMS and SMS. This can take place either on the system website or mobile application, or embedded within the business's website or mobile application.

2 A Physical World Transaction with a Retailer or Service Provider

Physical world tip transactions with retailers or service providers require authentication at the moment the customer pays. The business employee taking the payment from the customer enters a single use authentication code into the system mobile application running on the customer's electronic computing device (e.g. smartphone). If the price is variable (in the case of a meal or if a flat percentage discount is being offered) the business employee also enters the total value of the transaction and the customer confirms this amount. The system mobile application then issues the system with an instruction to automatically charge the business for the transaction. After the business is successfully charged, the system sends a message back to the system mobile application confirming tip redemption and displaying the customer's new account balance on the system. The customer is then given the opportunity to pass the tip on to their friends via Twitter, Facebook, Email, SMS, etc. . . .

In most cases the tip provider in the transaction is automatically identified from the record of when the tip was issued. When a user provides a tip to specific friends, the user gains the right to receive the tip provider commission if any of his/her friends redeems the tip (as long as no one else has provided the friend with the same tip previously). Also in the case where the tip was broadcast via Twitter, as long as the customer has also registered their Twitter account with system the tip provider can be automatically identified. If no tip provider can be identified, the customer is given the option of entering the name of the system user who gave them the tip. The system then looks for the nearest match to the name amongst known friends of the customer.

On the business side of the transaction there are a number of options as to where the business employee can obtain the single use authentication code. At the most basic level, the system website will allow physical world businesses to print out a sheet of single use authentication codes. After a business employee has entered a code into a customer's smartphone they cross it off the sheet with a pen. Alternatively both the system website and the system business mobile application will allow authentication codes to be created when required. Permissions (for both the website and system mobile application) will enable detailed access rights to be assigned to specific employees and also allow the identity of which employee created which authentication code and the associated transaction to be tracked. One step up from this is direct integration with POS systems; this is how the system will integrate with larger retail chains. With this option a system redemption code can be printed on the receipt in QR and/or numerical code format. The customer can then enter this code into the system mobile app or website to redeem the tip.

This method of integration is advantageous in high frequency retail environments as it does not extend the length of time a checkout worker must spend processing each checkout transaction.

### 3 A Physical World Purchase or Consumption of a Tip-able Product

Product manufacturers can offer rebates direct to their customers via the system, bypassing retail. A unique single use tip redemption code is printed on the product in a location only accessible after the product is opened. After purchase the customer enters this code into either the system mobile application, website or Facebook application to claim the discount. The customer is then given the opportunity to tip the product to their friends via Twitter, Facebook, Email and SMS. At the moment the customer enters the tip redemption code, the product manufacturer is charged by the system.

The tip provider in the transaction is identified by exactly the same means as when a physical world tip transaction with a retailer or service provider is processed (see above). This same category of tip can also be used with ephemeral products like TV and radio adverts or to reward individuals who gather in a specific location (e.g. first 500 people to arrive at a festival).

### Exemplifications for Determining User's Levels

### Collectible Medals (Awards) and Leveling for Individuals

The system may further award tip providers, consumers, and businesses awards (e.g. medals) and a level (e.g. rating or scoring) system for the most active and committed users. Medals are collected as rewards for the completion of certain tasks, and when a user collects a certain number medals they are promoted to the next level. A visible medal will be added to the user's profile on all the system platforms (Mobile, Facebook, web, etc. . . . ) for each reward collected. When a user starts to make progress towards obtaining a medal, a graphic will appear that previews the medal, shows progress and informs the user of the steps they need to undertake to complete acquiring the reward. Limited numbers of custom medals will also occasionally be made available. For example, Table 1 displays an exemplification of awards.

TABLE 1

| Award Name | Description | Value |
|---|---|---|
| Tipp | Share 10 Tipps | 1 medal |
| apprentice | (each of which must be redeemed at least once) | |
| Tipp hero | Share 25 Tipps | 1 medal |
| | (each of which must be redeemed at least once) | |
| Tipp genius | Share 50 Tipps | 1 medal |
| | (each of which must be redeemed at least once) | |
| Tipp deity | Share 100 Tipps | 1 medal |
| | (each of which must be redeemed at least once) | |
| Social | Introduce 5 new users to Tippstr | 1 medal |
| apprentice | (each of which must redeem at least 2 Tipps) | |
| Social hero | Introduce 10 new users to Tippstr | 1 medal |
| | (each of which must redeem at least 2 Tipps) | |
| Social genius | Introduce 25 new users to Tippstr | 1 medal |
| | (each of which must redeem at least 2 Tipps) | |
| Social deity | Introduce 50 new users to Tippstr | 1 medal |
| | (each of which must redeem at least 2 Tipps) | |
| Business | Introduce 3 new businesses to Tippstr | 2 medals |
| apprentice | (each of which must transact at least 10 Tipps) | |
| Business | Introduce 5 new businesses to Tippstr | 1 medal |
| leader | (each of which must transact at least 10 Tipps) | |
| Business | Introduce 10 new businesses to Tippstr | 1 medal |
| baron | (each of which must transact at least 10 Tipps) | |
| Five in a | Introduce five friends or businesses to Tippstr within five | 5 medals |
| row | consecutive days and gain 5 medals for five weeks | for five |
| | | weeks only |
| Golden | Over fifty Tippstr transactions or introductions (other than | 10 medals |
| month | introducing a business) in the previous month. Introducing a | for one |
| | business is the equivalent of 10 transactions. All transactions over | month only |
| | fifty are rolled over to the next month (and go towards claiming a | |
| | subsequent golden month). However if there are less than fifty | |
| | transactions these are lost at the end of the month and the user has | |
| | to start collecting again. The golden month only lasts for one | |
| | calendar month. | |
| Golden | If a user receives 3 golden months in a row, they qualify for a | 10 medals |
| quarter | golden quarter. | for three |
| | | months |
| | | only |
| Tycoon | One XP for every $1000 in a user's Tippstr account | 1 medal for |
| | | every |
| | | multiple of |
| | | $1000 in |
| | | account |
| Golden | Every time a user uncovers a Golden Tipp and the Golden Tipp is | 0 medals |
| Tipp | redeemed by at least three of their friends they receive a ‘Golden | |
| hunter | Tipp hunter’ award. This award is purely a decorative memorial to | |
| | finding a Golden Tipp and adds no XP bonus as the user has | |
| | already received boosted Tipp commission from at least three | |
| | transactions | |

As a user gains more medals they are promoted to higher system levels. Each level offers increased commissions by unlocking commission payments from the friends of friends they have introduced to the system, as shown in Table 2

TABLE 2

| | | No. of |
|---|---|---|
| Level | Benefit | Medals |
| Bronze | Claims commission on Tipps and introductions. | 0 |
| Silver | Receive commission from 1st generation | 2 |
| | descendants. | |
| Gold | Receive commission from 2nd generation | 4 |
| | descendants. | |
| Platinum | Receive commission from 3rd generation | 8 |
| | descendants. | |
| Diamond | Receive commission from 4th generation | 16 |
| | descendants. | |
| Deity | Receive commission from 5th generation | 24 |
| | descendants. | |

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer program product comprising program code on at least one computer readable storage device that, when executed by at least one computing device, rewards users for sharing retail offers to contacts when the offers are redeemed, the computer program product comprising:
a) program code configured for users creating and storing an account on the networked system, wherein the type of users comprise:
i) business's making said offer for goods, services, or activity in exchange for a reward;
ii) tip providers sharing said offer with consumers;
iii) consumers redeeming said offer; and,
iv) wherein each user may be one or more of said types;
b) program code configured for creating and transmitting by said businesses said offers to said tip providers;
c) program code configured for designating and transmitting by said tip providers, said offers to selected consumers; and,
d) program code configured for calculating and transmitting payments by the system processor when said offer is redeemed by said consumer.

2. The computer program product of claim 1, wherein said tip provider need not redeem said offer before forwarding said offer to consumers in order for said tip provider to receive a payment if the offer is redeemed.

3. The computer program product of claim 1, wherein said offer redeemed by the consumer are selected from the group consisting of one or more of, a discount, a free upgrade, and credit towards future purchases of said business's or another business's product or services.

4. The computer program product of claim 1 further comprising program code configured for calculating the score of the business, tip provider, and consumer in effectively creating and sharing offers, wherein high score earners receive additional benefits from the system comprising exclusive offers, free products and services, and public visibility.

5. The computer program product of claim 1 further comprising program code for customizing offers to a tip provider's and consumer's geographical location, preferences, habits, and attributes that are captured by the system from the user's electronic computing device.

6. The computer program product of claim 1, wherein said tip provider transmits said offer to said consumer via email, short message service, social network personal message, social network public posting, blog post, mobile device application, and/or a website.

7. The computer program product of claim 1, wherein said consumer redeems said offer in person at said business, on an automated telephone service, via a system mobile application or website, or on the business's website comprising a link to the system.

8. The computer program product of claim 1, wherein said payments processed by the system comprise marketing fees billed to said business whose offers are redeemed, commissions paid to said tip providers, and said offers paid to said consumers.

9. The computer program product of claim 1, wherein creating said offer comprises the business paying an upfront fee to said system; and said payments processed by the system comprise commissions paid to said tip providers, and said offers paid to said consumers.

10. The computer program product of claim 1, wherein said commissions paid to said tip provider comprises a monetary payment, and/or a discount on a future purchase.

11. The computer product of claim 1, wherein said payments processed by the system comprises commissions to each user who shares an offer within the chain of an offer being transmitted from user-to-user.

12. The computer program product of claim 1, wherein said offer is a discount or bonus based upon the total number of consumers who redeem said offer.

13. The computer product of claim 1, wherein said payments processed by the system comprise commissions paid to a tip provider for each subsequent offer redeemed by a consumer who registered on the system in response to a first offer sent from said tip provider.

14. The computer product of claim 1, wherein said tip provider recommends offer to business, and gets multiple consumers to commit to redeeming offer beforehand, or makes a counter offer to said business, or receives permission to buy and resale said offer.

15. A computerized method for rewarding users for sharing retail offers to their contacts when the offers are redeemed, the computer program method comprising:
a) creating and storing an account on a networked system, wherein the type of users comprise:
i) business's making said offer for goods, services, or activity in exchange for a reward;
ii) tip providers sharing said offer with consumers;
iii) consumers redeeming said offer; and,
iv) wherein each user may be one or more of said types;
b) creating and transmitting by said businesses said offers to said tip providers;
c) designating and transmitting by said tip providers, said offers to selected consumers; and,
d) calculating and transmitting payments by the system processor when said offer is redeemed by said consumer.

16. The computerized method of claim 15, wherein said tip provider need not redeem said offer before forwarding said offer to consumers in order for said tip provider to receive a payment if the offer is redeemed.

17. The computerized method of claim 15, wherein said offer redeemed by the consumer are selected from the group consisting of one or more of, a discount, a free upgrade, and credit towards future purchases of said business's or another business's product or services.

18. The computerized method of claim 15 further comprising program code configured for calculating the score of the business, tip provider, and consumer in effectively creating and sharing offers, wherein high score earners receive additional benefits from the system comprising exclusive offers, free products and services, and public visibility.

19. The computerized method of claim 15 further comprising program code for customizing offers to a tip provider's and consumer's geographical location, preferences, habits, and attributes that are captured by the system from the user's electronic computing device.

20. The computerized method of claim 15, wherein said tip provider transmits said offer to said consumer via email, short message service, social network personal message, social network public posting, blog post, mobile device application, and/or a website.

21. The computerized method of claim 15, wherein said consumer redeems said offer in person at said business, on an automated telephone service, via a system mobile application or website, or on the business's website comprising a link to the system.

22. The computerized method of claim 15, wherein said payments processed by the system comprise marketing fees billed to said business whose offers are redeemed, commissions paid to said tip providers, and said offers paid to said consumers.

23. The computerized method of claim 15, wherein creating said offer comprises the business paying an upfront fee to said system; and said payments processed by the system comprise commissions paid to said tip providers, and said offers paid to said consumers.

24. The computerized method of claim 15, wherein said commissions paid to said tip provider comprises a monetary payment, and/or a discount on a future purchase.

25. The computerized method of claim 15, wherein said payments processed by the system comprises commissions to each user who shares an offer within the chain of an offer being transmitted from user-to-user.

26. The computerized method of claim 15, wherein said offer is a discount or bonus based upon the total number of consumers who redeem said offer.

27. The computerized method of claim 15, wherein said payments processed by the system comprise commissions paid to a tip provider for each subsequent offer redeemed by a consumer who registered on the system in response to a first offer sent from said tip provider.

28. The computerized method of claim 15, wherein said tip provider recommends offer to business, and gets multiple consumers to commit to redeeming offer beforehand, or makes a counter offer to said business, or receives permission to buy and resale said offer.
